(19) United States
(12) Patent Application Publication
(10) Pub. No.: US 2016/0192732 A1
(43) Pub. Date: Jul. 7, 2016

(54) FOREFOOT CUSHION, COMPUTER PROGRAM PRODUCT FOR PROVIDING THE FOREFOOT CUSHION AND METHOD FOR PROVIDING THE FOREFOOT CUSHION

(71) Applicant: LENTHE & LICHT KG, Oyten (DE)

(72) Inventor: Christian LENTHE, Oyten (DE)

(73) Assignee: LENTHE & LICHT KG, Oyten (DE)

(21) Appl. No.: 14/912,666

(22) PCT Filed: Aug. 20, 2014
(86) PCT No.: PCT/EP2014/067753

§ 371 Date: Feb. 18, 2016

(30) Foreign Application Priority Data
Aug. 22, 2013 (DE) 20 2013 103 808.3

(51) Int. Cl. A43B 7/14; G05B 15/02; B29D 35/00; A43B 7/28; A43B 17/00

(52) U.S. Cl. CPC A43B 7/1425; A43B 7/149; A43B 7/28; A43B 17/003; B29D 35/0009; G05B 15/02

(57) ABSTRACT

The invention relates to a forefoot cushion (1), in particular for insertion into shoes having heels. The forefoot cushion (1) has a bottom side which can be applied to a shoe and a top side which is positioned opposite the bottom side. The problem addressed by the invention is to improve known forefoot cushions. That problem is solved in that the forefoot cushion (1) has at least one zone (3, 5, 7), each zone (3, 5, 7) being incorporated from the bottom side into the forefoot cushion (1). Moreover, the at least one zone (3, 5, 7) is not visible from the top side of the forefoot cushion (1), so that a flat, not curved surface (9) is achieved in the upper part of the forefoot cushion (1). As a result, one or more metatarsal heads (21) can sink into the zone or zones (3, 5, 7), such that a pressure relief takes place. The invention further relates to a computer program product for quick, simple and individual providing or producing or selecting such a forefoot cushion (1). Analogous to the device, the invention relates to a method for providing, for example for producing or selecting, such a forefoot cushion (1).

The present invention relates to a forefoot cushion according to the preamble of claim 1, a computer program product for providing such a forefoot cushion according to claim 8 and a method for providing such a forefoot cushion according to claim 10.

A person during standing does charge particularly three points with his weight: the heel bone (calcaneus), the big toe joint (first metatarsal) and the small toe joint (fifth metatarsal). The first, second, third, fourth and fifth metatarsal head form a transverse arch, which flattens with advancing age by the load of the body weight. The charged pressure is hereby partially displaced from the first and fifth metatarsal heads to the metatarsal heads lying between, i.e. to the second, third and fourth metatarsal head.

Especially when wearing shoes with little volume capacity, a thin outsole and heels, after a certain time pressure problems in the forefoot area occur. When wearing shoes with heels, bending between toe bones (phalanges) and metatarsal bones (metatarsalia) causes the center of load to be displaced particularly onto the first, second, third, fourth and fifth metatarsal heads. The time taken until pressure problems occur gets smaller with increasing height of the heels.

Forefoot cushions for retrofitting of footgear are known in the prior art. They should reduce the pressure in the forefoot when being worn and therefore improve comfort. However, many forefoot cushions are designed very simple and do not bring the desired effect. In addition, the forefoot cushions are related to certain symptoms of disease and therefore are not specifically designed to be worn in shoes with higher heels, such as high heels.

An insert well-known in the prior art, namely from US 2005/0166425 A1, for example, is designed for patients with a diabetic foot. The insert includes a plurality of sections, which can be shaped differently. Here, for example, several pillow-like structures are placed into the insert. So, for example, five pillow-like divided areas for different toes are arranged in the front section of the insert. Also, this prior art shows two circular depressions in the insert, which should reduce the pressure on the metatarsal heads. The insert is formed from several layers of cork and a top layer of leather.

The prior art has the disadvantage that the insert made of cork and leather is little pliable when pressure is released and thus for prolonged wear, especially in high-heeled shoes, pain in the forefoot area still occurs. Furthermore, the insoles in the prior art are usually unattractive in their appearance so that particularly young people can poorly identify with such a product and form a positive bond with the product. In addition, the way to an orthopaedist for making an insole takes much time.

It is therefore the object of the invention to improve the forefoot cushions known in the prior art and the customer's ability to obtain such a forefoot cushion in order to provide an attractive product.

The object is achieved by a forefoot cushion with a bottom side being applicable to a shoe and with a top side being positioned opposite the bottom side, which top side does form a lay-on surface for the foot. Concerning an insert, which is ready for use, the top side is thus oriented upward into the shoe and the bottom side is oriented downward. The forefoot cushion here comprises at least one zone for pressure relief of one or more metatarsal heads. Each zone is incorporated as a hollowing starting from the bottom into the forefoot cushion. Viewed from a side view, the hollowing or hollowings arch into the cushion, starting from the bottom side in direction to the top side.

The at least one zone is not visible from the top side of the forefoot cushion, thus resulting in a flat, non-curved surface in the upper part of the forefoot cushion. Consequently, this flat surface is arranged at a location on the top side of the forefoot cushion, which location is positioned opposite the one or more zones. Advantageously, the metatarsophalangeal joints or metatarsal heads are therefore firstly supported on an elastic intermediate layer before then sinking cushionedly into the hollowings. Thus, the metatarsal heads rest on a form of air cushion, so that at each step the pressure or the user's weight is cushioned.

According to an embodiment of the invention which can be combined—provided that no contradictions result—with one or more of the preceding and/or of the following features, the forefoot cushion comprises a first zone for pressure relief of the first metatarsal head and a second zone for pressure relief of the fifth metatarsal head. Thus advantageously, those metatarsal heads are cushioned which are charged with the most pressure. Particularly preferably, the zones or hollowings are formed circular. This is advantageous for the reason, so that the metatarsal heads, which are also formed approximately circular in cross section, in each case optimally fill the respective hollowing. Alternatively, the hollowings can be adapted even more precisely in its shape to the shape of each metatarsal head to be received.

According to an embodiment of the invention which can be combined—provided that no contradictions result—with one or more of the preceding and/or of the following features, the forefoot cushion comprises a third zone for pressure relief of the second, third and/or fourth metatarsal head. Due to the fact that the transverse arch lowers with age, pressure is charged increasingly on the second, third and fourth metatarsal head. By the third zone these areas of the foot can therefore be cushioned. The zone can be designed as a coherent large zone or can be divided into sections. Each section is designed as a hollowing. For so example, a third zone with three sections for each second, third and fourth metatarsal head could be provided. Alternatively, any other combination of hollowings or sections can be provided for the second, third and fourth metatarsal head (for example, a third zone with hollowings or sections for the second and third metatarsal head). Thus, each metatarsal head can be cushioned individually or separately. In another alternative, the first, the second and the third zone can be merged to form a coherent large zone.

According to an embodiment of the invention which can be combined—provided that no contradictions result—with one or more of the preceding and/or of the following features, the forefoot cushion comprises a raising on the top side. This for example can be a pelotte. The raising or the pelotte serves to support the arch zone, which is returned into its natural shape by the raising and which reduces the pressure on the second to fourth metatarsal head. The arch zone is in particular the transverse arch of the foot.

The forefoot cushion is advantageously designed in such a way that during usage the hollowings are arranged or are arrangeable in the area of the metatarsal heads. While wearing the shoe, they thus are positioned opposite the metatarsal heads, so that the metatarsal head can sink into the hollowings. Simultaneously, the raising is placed in the area of an arch, preferably of the transverse arch, so that the respective arch is supported by the raising.

According to an embodiment of the invention which can be combined—provided that no contradictions result—with one or more of the preceding and/or of the following features, the forefoot cushion has an adhesive surface in at least one section of the bottom side. This allows—during wearing it in a shoe—to prevent the forefoot cushion from slipping. Alternatively or additionally, also the top side is designed with an adhesive or slip resistant surface, so that the foot, which lies on the cushion, changes its position to a lesser extent.

According to an embodiment of the invention which can be combined—provided that no contradictions result—with one or more of the preceding and/or of the following features, the forefoot cushion is made out of elastic material. Particularly preferably, the forefoot cushion comprises silicone. Particularly preferably, the forefoot cushion comprises platinum-catalyzed addition-crosslinking silicones, particularly warm-crosslinking LSR-silicone rubber (liquid silicone) or cold-crosslinking silicone rubber. Silicone or silicone rubber is advantageously characterized by high heat resistance, good resistance to low temperatures and good cold flexibility, weather resistance, chemical resistance and water repellency. Moreover, silicone is physiologically harmless and a very precise shape of the object to the smallest detail with uniform curing is possible. During vulcanization or crosslinking, the silicone or silicone rubber is transferred into a rubber-elastic state. Thereby, the properties change from plastic to elastic.

Cold-crosslinking silicone rubber (or RTV-silicone rubber=room-temperature-crosslinking silicone rubber) can be crosslinked at room temperature with the involvement of humidity of the air. The processing of the material is very simple and does not require expensive equipment. The rubber made in this process has permanently elastic properties and returns to its original position under mechanical stress, has a high tensile strength and elongation and resistance to aging. The foot is advantageously cushioned at the pain-sensitive points by the elastic material. In addition, the metatarsal heads can advantageously sink into the hollowings.

According to an embodiment of the invention which can be combined—provided that no contradictions result—with one or more of the preceding and/or of the following features, the forefoot cushion is made by injection molding. In particular, the injection molding can be carried out by means of a casting mold. This method has the advantage that objects with high accuracy can be produced in a short time. The surface of the object can be freely selected.

According to an embodiment of the invention which can be combined—provided that no contradictions result—with one or more of the preceding and/or of the following features, at least a section of the raising comprises a different material than the rest of the forefoot cushion. Thereby, it is possible that the section of the raising or the entire raising comprises other properties than the rest of the forefoot cushion. For example, the raising can be formed pillow-like, so that this area is more resilient and thus a stronger sinking of the corresponding pedal region is possible.

According to an embodiment of the invention which can be combined—provided that no contradictions result—with one or more of the preceding and/or of the following features, the hollowings of each zone are fillable with the same or a different material as the rest of the forefoot cushion. If the filling material in the hollowings is the same material as the rest of the forefoot cushion, for example silicone rubber, then the appropriate zones do not represent discharge zones since the metatarsal heads of the foot cannot sink—with respect to the vicinity of the metatarsal heads—into the forefoot cushion. In this case, hollowings not being filled, which hollowings serve as discharge zones, have a stronger effect. If one or more hollowings are filled with another material, which material is, for example, more elastic than the surrounding material of the remaining forefoot cushion, then the degree of sinking can be determined by selecting the elasticity of the filling material.

According to an embodiment of the invention which can be combined—provided that no contradictions result—with one or more of the preceding and/or of the following features, the degree of hardness of the forefoot cushion is adaptable. The hardness of the forefoot cushion is preferably controlled by the choice of the elasticity of the material. Advantageously, an individual adaptation to the user's weight can be carried out by adjusting the degree of hardness.

According to an embodiment of the invention which can be combined—provided that no contradictions result—with one or more of the preceding and/or of the following features, the diameter of the circular hollowings is variable. Particularly preferably, the diameter of the hollowing is adapted to the metatarsal head to be accommodated respectively. The zone or hollowing of the first metatarsal head has, for example, a larger diameter than the zone or hollowing of the fifth metatarsal head, since the diameter of the first metatarsal head (belonging to the big toe) is greater than that of the fifth metatarsal head (belonging to the little toe). Thus, for each metatarsal head just as much space in the hollowing is provided to ensure a pleasant sinking.

According to an embodiment of the invention which can be combined—provided that no contradictions result—with one or more of the preceding and/or of the following features, the dimensions of forefoot cushions are chosen such that only those sections of the foot are produced as a forefoot cushion, which are required for the desired application. Thus, the forefoot cushion does not relate to a complete sole, but a correspondingly smaller cushion, which is especially applicable in the forefoot area.

According to an embodiment of the invention which can be combined—provided that no contradictions result—with one or more of the preceding and/or of the following features, the forefoot cushion is designed in color and/or can get a printed lettering and/or an image. Advantageously, in particular young public is encouraged to buy the product by this embodiment. The reason for this is that, typically, insoles have a negative image particularly among the younger population, so that such insoles are associated with something unpleasant and embarrassing. A forefoot cushion, however, which is designed in bold colors can overcome this prejudice and can convince also the young population to wear such a product.

According to an embodiment of the invention which can be combined—provided that no contradictions result—with one or more of the preceding and/or of the following features, the forefoot cushion is adjusted individually to its user. In particular, by this, different malpositionings such as fallen arches, flatfoot, skew foot, splay foot and hallux valgus can be considered. The customer can select individually, for example, for which metatarsal heads a relief zone is to be created. Particularly preferably, it is possible that the depth of the zones or the thickness of the interlayer can be designed individually. Alternatively or in addition, the raising can be selectable with respect to shape, structure of the surface and the manner of sinking. Particularly preferably, an individual adjustment of the forefoot cushion to the foot size is carried out. The customizability of the forefoot cushion has the advantage that each user can customize or select the forefoot cushion according to his preferences and/or necessary adjustments. Alternatively, an individual selection from different variants of the forefoot cushion takes place.

According to an embodiment of the invention which can be combined—provided that no contradictions result—with one or more of the preceding and/or of the following features, a foot pressure measurement or pedography can be carried out for individualizing the forefoot cushion. In doing so, the pressure loading of the foot is determined during standing. Based on this data, the forefoot cushion can then advantageously be designed individually.

According to an embodiment of the invention which can be combined—provided that no contradictions result—with one or more of the preceding and/or of the following features, the forefoot cushion comprises a positioning aid. The positioning aid is, for example, optically and/or haptically detectable by the user. The positioning aid can in particular be positioned as a line at the bottom side of the forefoot cushion, in which though a part of the line is advantageously also visible on the top side. In particular, in this case parts of the line are arranged at the left and right outer edge of the forefoot cushion with respect to a plan view on the top side. Alternatively, the positioning line can be introduced only onto the bottom side or only onto the top side. The positioning aid is preferably introduced transversely onto the longitudinal side of the forefoot cushion.

In particular, the positioning aid—with respect to a plan view on the forefoot cushion—is introduced onto below the zones, and thus below the flat surface. If the forefoot cushion has a pelotte, then the positioning aid is positioned between the zones and the pelotte—and thus outside the flat surface—and marks the position at which the forefoot cushion is to bend in a high-heeled shoe. This position corresponds to the transition between the flat front section of the shoe and the rear part of the shoe, which rear part rises in high heels. By means of the positioning aid it is possible for the user to insert the forefoot cushion in a proper position inside the shoe, so that the positive effect of the forefoot cushion for the user is maximum or nearly maximum. Advantageously, a manual teaches instructions for the correct positioning of the forefoot cushion by means of the positioning aid, said manual being enclosed to the forefoot cushion.

If the positioning aid is designed haptic, then the line is tactile, so that correct positioning of the forefoot cushion in the shoe is also possible by these means. A haptic design of the positioning line can, for example, be realized by notches or deepenings, and, for example, the casting mold for the forefoot cushion can be designed such that the notches or deepenings occur. The positioning aid can also be designed simultaneously visual and haptic.

According to an embodiment of the invention which can be combined—provided that no contradictions result—with one or more of the preceding and/or of the following features, if also the forefoot cushion is made of polymers, particularly preferred silicones, more preferably silicone rubber, the forefoot cushion comprises a glossy or smooth surface at least in one section. Particularly preferably, the at least one section is positioned at the bottom side of the forefoot cushion and extends in particular over the entire bottom side. Here, a display of information, as described below, can be present in the smooth section, wherein the smoothness of the surface is breached in this smooth section for presenting information in such a way that the surface, which is used to display information, comprises a rough surface as described below. An improved adhesion of the forefoot cushion in the shoe results from a smooth surface of polymers, silicones or silicone rubber. In particular, there is an adhesion between the forefoot cushion and the shoe. Slipping of the forefoot cushion, especially when walking, is thereby prevented. The smooth surface thus is slip-resistant.

According to an embodiment of the invention which can be combined—provided that no contradictions result—with one or more of the preceding and/or of the following features, if also the forefoot cushion is made of polymers, particularly preferred silicones, more preferably silicone rubber, the forefoot cushion comprises at least one section with a matte or rough surface made of silicone rubber. Here, a display of information, as described below, can be present in the rough section, wherein the surface roughness is breached in this rough section for the display of information in such a way that the surface, which serves to display information, comprises a smooth surface, as described below.

Preferably, information are provided or displayed in the rough and/or in the glossy sections of the forefoot cushion. For example, these information can be the URL (abbreviation for “Uniform Resource Locator”) of a website for ordering the forefoot cushion, information for positioning (for example, an indication of the top side, bottom side, right side and/or left side of the forefoot cushion), the shoe size, a brand logo and/or the positioning aid.

The display of the information in a smooth section is preferably carried out by means of design of the information with a rough or matte surface. In a rough section the display of information is carried out with a smooth and glossy surface. Particularly, for example, the individual characters of a pictured group of characters are designed as a smooth surface in a rough section and as a rough surface in a smooth section. Thus, the group of characters stands out from the respective surrounding rough or smooth section, making it visually detectable for a user. This applies analogously to the display of brand imprints or logos.

Alternatively or additionally, the characters, brand imprints and/or logos can be introduced haptic by means of deepenings into the forefoot cushion.

Information can be presented in the manner described above only in the rough section, which preferably extends over the top side of the forefoot cushion or only in the smooth section, which preferably extends over the bottom side of the forefoot cushion, or in the rough and in the smooth section. Preferably, the majority of the information is shown in the smooth section on the bottom side. Particularly preferred, the only information on the rough top surface is a part of the positioning line.

Particularly preferably, the forefoot cushion comprises both at least one matte or rough as well as at least one glossy or smooth section. Both the matte and the glossy surface are determined by the surface roughness and can already be predetermined with the design of the mold for the injection molding process. The information in the section with the matte surface is particularly preferably also predetermined by the casting mold, so that the information is present in the forefoot cushion in a marked manner, i.e. hollow or raised, especially preferably hollow. By these means, the positioning aid can be designed, for example, haptic.

The invention further relates to a computer program product for providing, in particular individual producing or selecting such forefoot cushion. The computer program product in particular is stored on a computer readable medium or is implemented as a signal. In particular, it can be accessed and controlled via a website. The computer program product causes, when it is loaded into the memory of a computer and executed by a computer that the computer provides at least one form, by means of which form data can be input. These data are, for example, the individual design data of the user and/or personal information of the user, such as name, address, etc. The computer program product reads this data and stores it. In addition, the entered or read data are processed and evaluated.

In response to these data being evaluated a production process, in particular a machine, is controlled then, for example, which production process or machine produces a forefoot cushion according to the data or a forefoot cushion is being selected according to the data.

Such a computer program product provides an easy and quick way for a user to get an individual forefoot cushion. In particular, it offers the possibility of producing a forefoot cushion individually or it provides the ability for the sales department to collect data for the individual selection of forefoot cushions. The computer program product provides these data for production or for selecting a forefoot cushion.

According to an embodiment of the invention which can be combined—provided that no contradictions result—with one or more of the preceding and/or of the following features, the computer provides selection means on the website. The data collected through this selection means, which data, for example, relate to the specification of the shoe size and/or the selection of one or more zones, then serve as a basis for selecting a forefoot cushion from different stored versions of the forefoot cushion or for the control of the machine by the computer for the individual design or production of the forefoot cushion.

On the website, for example, pictures of feet or of forefoot cushions with all kinds of relief zones can be shown as selection means. Preferably, the website can be designed such that by clicking on a zone in the pictures, this zone is selected for production. In particular, the computer program product can also be designed such that different colors of the forefoot cushion or imprints onto the forefoot cushion are selectable. For example, it might be possible for the user to provide an individual picture, which picture is printed onto the forefoot cushion or which picture is placed in the forefoot cushion during the production process. In a final step, the product can be sent to the respective user via mail by linking the personal data (for example name and address) with the individualized forefoot cushion.

According to an embodiment of the invention which can be combined—provided that no contradictions result—with one or more of the preceding and/or of the following features, a foot pressure measurement kit for self-measurement of foot pressure is provided at the customer's request before passing an order on the website. This can, for example, include the provision of a digital measuring paper for printing and a manual. For example, it can be provided to rub the bottom of the foot with color, so that when stepping on the measuring paper, an imprint is created. In addition, the manual could contain interpretations for the imprint, so that a simple and quick selection of individual relief zones is possible for the customer.

The computer program product controls, for example, a method for the production of the forefoot cushion. In this way the forefoot cushion is produced individually according to the wishes of the customer. A storage is not necessary in this case.

The method for providing the forefoot cushion relates to the introduction of one or more features of the above-mentioned product or selecting of the product according to one or more of the above-mentioned features. The provision can therefore be, for example, a production or selecting of the forefoot cushion. In the case of production the at least one zone gets incorporated as a hollowing from the bottom side into the forefoot cushion, while in the case of selecting, the at least one zone is incorporated as a hollowing from the bottom side into the forefoot cushion. The method for the production can be carried out either in response to the data entered by the user or for pre-production with storage and later selection of a variant in response to the data entered by the user.

Particularly preferably, the body of the forefoot cushion is individually made first by injection molding using silicone. An adhesive surface—such as a smooth bottom side—which prevents slipping in the shoe, can, for example, already be produced during the production process of the body or even later by applying to the surface. If at least one section of the raising is made from a different material than the body of the forefoot cushion, then this different material can be coated by the silicone during injection molding. Alternatively, the top side and the bottom side are produced separately by injection molding and the raising's different material gets imbedded when joining the halves.

The method for the individual selection of a forefoot cushion relates to the selection of a forefoot cushion from different variants of the forefoot cushion with the features of the device or of the production method. In particular, the selection is made in response to evaluated data of a user. The selection process can be extended by further steps. Below, a possible process is described. Initially, different variants of the forefoot cushion are provided or produced. In the case of providing, the forefoot cushion can, for example, be produced and bought externally. A production is preferably carried out according to the above-described method for producing a forefoot cushion.

The different variants of forefoot cushions are stored after providing or producing. Preferably, in each case similar embodiments of the forefoot cushion can be stored together, so that an overview of the stock and a quick location of a specific variant is possible.

In addition, the data of the computer program product described above, which have been entered using the form on the website and which have been processed and evaluated by the computer, are used to select a particular variant of the stored forefoot cushion used. A user can therefore input his desired data for designing the forefoot cushion to the computer program product via the website, wherein a computer, on which the computer program product is executed, processes and evaluates the data. According to these data then the variant of the forefoot cushion which was requested by the user is selected from the stored forefoot cushions. Subsequently, the forefoot cushion is rendered to the user, for example by mail.

According to an embodiment of the invention which can be combined—provided that no contradictions result—with one or more of the preceding and/or of the following features, the variants of forefoot cushions relate to the shoe size, to the embodiment of one or more zones and the coloring of forefoot cushions. Preferably, forefoot cushions are stored for both the left and the right foot with different shoe sizes, zones and colors. Preferably, the shoe sizes are combined. That is, for example, one size of a forefoot cushion for European shoe size between 36 and 38, 39 to 41 and 42 to 44 will be provided each. Alternatively, other combinations are possible. Such combination reduces the space for storage.

Analogously, in each case one size of a forefoot cushion for US shoe sizes 5 to 7, 7½ to 9½ and 10 to 12 according to the FIA (Footwear Industries of America) standard can be provided.

In addition to the different variants for the left and right foot and for the shoe size, variants with different configurations with respect to the zones are provided. Preferably, the variants of the design of the first zone, the second zone and the third zone are covered, wherein particularly preferably only one of the zones is being introduced into the forefoot cushion. In addition, these variants already described are available in several colors each, for example, in the colors red, green and blue. By above-mentioned selection means each desired variant can be selected and ordered on the website.

Further advantageous embodiments of the invention, which—as long as there is no contradiction—can be combined with one or more of the preceding and/or the following features, which will emerge from the subclaims and from exemplary embodiments explained with reference to the drawings. In the drawings:

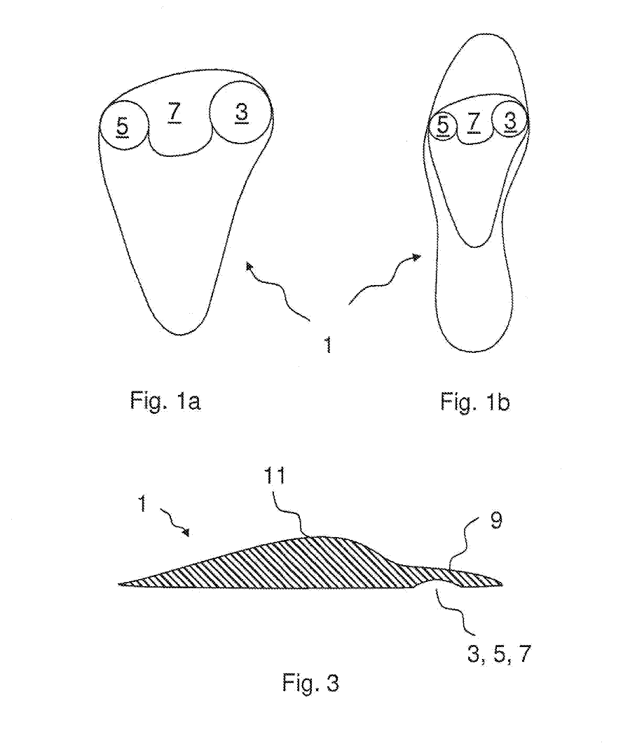

FIG. 1a is a view of the bottom side of the forefoot cushion for the right foot in accordance with an embodiment of the invention,

FIG. 1b is a view of the bottom side of the forefoot cushion for the right foot on the schematic outline of a foot or shoe according to an embodiment of the invention,

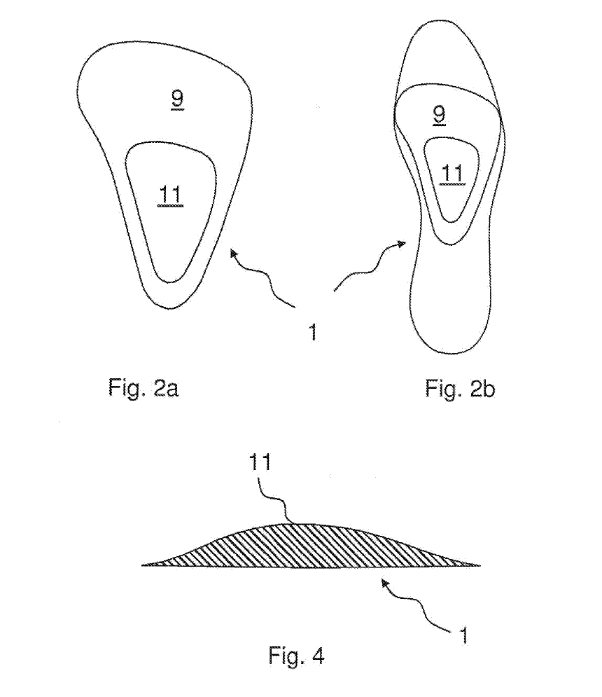

FIG. 2a is a view of the top side of the forefoot cushion for the right foot in accordance with an embodiment of the invention,

FIG. 2b is a view of the top side of the forefoot cushion for the right foot on the schematic outline of a foot or shoe according to an embodiment of the invention,

FIG. 3 is a sectional side view of the forefoot cushion according to an embodiment of the invention,

FIG. 4 is a sectional front view of the forefoot cushion according to an embodiment of the invention and

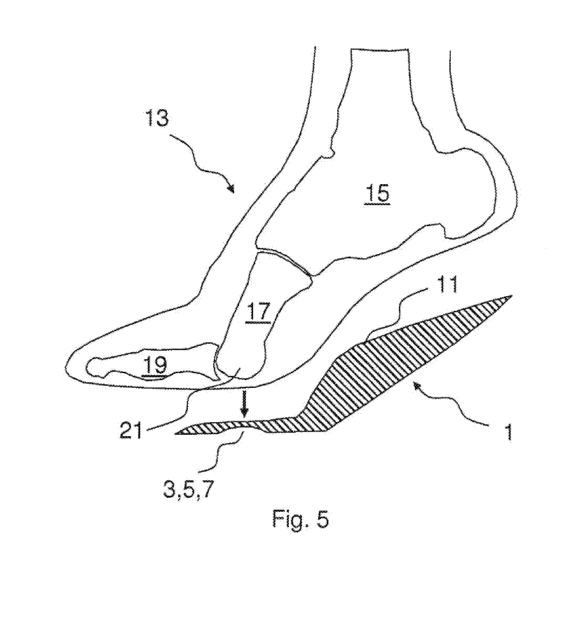

FIG. 5 is a schematic view of a foot and a forefoot cushion according to an embodiment of the invention.

FIG. 1a shows the bottom side of a forefoot cushion 1 for the right foot with a first zone 3, a second zone 5 and a third zone 7. The first zone 3 serves to receive the first metatarsal head and the second zone 5 for receiving the fifth metatarsal head. Zones 3, 5 are designed circular, which approximately corresponds to the shape of the metatarsal heads. The first zone 3 here has a larger diameter than the second zone 5. This is advantageous because the fifth metatarsal head, which corresponds to the little toe, has a smaller footprint than the first metatarsal head (which corresponds to the big toe).

The third zone 7 is arranged between the first zone 3 and the second zone 5. It is introduced into the forefoot cushion 1 for support of the second to the fourth metatarsal head. It is possible to divide the third zone 7 in a plurality of sections or hollowings, for example according to the number of metatarsal heads to be supported. Also, alternatively, the zones 3, 5, 7 can be joined to a large zone. Zones 3, 5, 7 bulge as hollowings each, starting from the bottom side toward the top side into the forefoot cushion 1. In FIG. 1a, the hollowings thus would arch into the picture (leading away from the viewer).

FIG. 1b shows the bottom side of the forefoot cushion 1 being positioned on an outline of a shoe or a foot. The approximately triangular shape of the forefoot cushion 1 lies approximately centrally on the foot.

FIG. 2a shows the top side of the forefoot cushion 1. The zones 3, 5, 7 cannot be seen from the top side of the forefoot cushion 1, such that a flat, non-curved surface 9 results in the upper part of the forefoot cushion 1. However, FIG. 2a shows a raising 11, being an increase with respect to the flat surface 9. In the view of FIG. 2a, the raising 11 therefore bulges out of the picture, thus toward the viewer.

Raising 11 also has an almost triangular shape and is placed in the lower part of the forefoot cushion 1. Raising 11 is thus, as can be seen in FIG. 2b, placed approximately in the area of the transverse arch of the foot. By raising 11 the transverse arch is advantageously supported, resulting in a more comfortable wearing of shoes. In addition, the raising 11 helps to slow the flattening of the transverse arch.

FIG. 3 shows a sectional side view of the forefoot cushion 1. The section lies approximately in the center of the longitudinal axis of the forefoot cushion 1. Clearly visible is the raising 11, which bulges upward toward the foot. In the front area of the forefoot cushion 1 one of the zones 3, 5, 7 or one of the hollowings is shown schematically. This zone or hollowing bulges from the bottom side towards the top side of the forefoot cushion 1. On the top side of the forefoot cushion 1, however, this hollowing cannot be seen, but only the flat surface 9. This flat surface 9 lower than the raising 11. A metatarsal head, which is supported on the flat surface 9, is therefore cushioned firstly on an intermediate layer between flat surface 9 and hollowing. Subsequently, it sinks into the hollowing or into one of the hollowings of one of the zones 3, 5, 7. The hollowing is therefore pressed down toward the shoe. Such a design offers a smooth sinking of the metatarsal head and further cushioning to the user during wearing. By these means, pain at the metatarsal heads can be reduced, especially when wearing such a forefoot cushion 1 long time.

FIG. 4 shows a sectional front view of the forefoot cushion 1. The forefoot cushion 1 is designed such that it flattens out towards the sides. This is important particularly in the area of raising 11 in order to achieve an actual support of the transverse arch. The body of the forefoot cushion 1 preferably consists of warm-crosslinking LSR-silicone rubber or of cold-crosslinking silicone rubber, wherein the raising 11 or parts of the raising 11 can be designed from a different material.

FIG. 5 shows a foot 13 schematically shown in simplified form with an abstract representation of the foot bones. The foot bones here include the tarsus 15, the metatarsal bones (metatarsals) 17 and the toe bones (phalanges) 19. When wearing a shoe with high heels, the phalanges 19 are almost in a 90-degree position with respect to the metatarsal bones 17. The metatarsal head 21 thereby stands almost vertically to the ground.

When treading on a forefoot cushion 1 according to the invention the metatarsal head 21, on which metatarsal head the user's weight is loaded, initially sinks on the flat surface 9, which flat surface 9 then depresses itself, such that the hollowings of the zones 3, 5, 7 flatten. The air that is located in the space of the hollowing escapes partially or almost completely. Raising 11 is located in the area of the transverse arch, which area of the transverse arch is placed between the metatarsal bone 17 and the tarsus 15. The transverse arch of the foot is supported advantageously by raising 11.

All features referred to in the above description and in the claims can both be combined individually and in any combination with the features of the independent claims. The disclosure of the invention is thus not limited to those combinations of features being described or claimed. Rather, all reasonable combinations of features should be considered as being disclosed in the present invention.

1: Forefoot cushion, in particular for insertion into shoes with heels, with a bottom side being applicable to a shoe and with a top side being positioned opposite the bottom side, which top side does form a lay-on surface for the foot (13), wherein the forefoot cushion (1) comprises at least one zone (3, 5, 7)—said zone being incorporated as a hollowing starting from the bottom side into the forefoot cushion (1)—for pressure relief of one or more metatarsal heads (21),
wherein
the at least one zone (3, 5, 7) is not visible from the top side of the forefoot cushion (1), so that a flat, non-curved surface (9) is achieved in the upper part of the forefoot cushion (1) and the forefoot cushion (1) is flattened toward the side, so that the forefoot cushion (1) does not cover the whole foot sole but just a section of the foot sole.

2: Forefoot cushion according to claim 1,
wherein
it comprises a first zone (3) for pressure relief of the first metatarsal head (21) and a second zone (5) for pressure relief of the fifth metatarsal head (21).

3: Forefoot cushion according to claim 1, wherein
it comprises a third zone (7) for pressure relief of the second, third and/or fourth metatarsal head (21).

4: Forefoot cushion according to claim 1, wherein
the forefoot cushion (1) comprises a raising (11), in particular a pelotte, on the top side, which serves to support the arch area, in particular the transverse arch, of the foot (13).

5: Forefoot cushion according to claim 1, wherein
the forefoot cushion (1) comprises an adhesive surface in at least one section of the bottom side.

6: Forefoot cushion according to claim 1, wherein
the forefoot cushion (1) comprises silicone, in particular warm-crosslinking LSR-silicone rubber or cold-crosslinking silicone rubber.

7: Forefoot cushion according to claim 1, wherein
the forefoot cushion (1) is made by injection molding.

8: Computer program product for providing, in particular for individual producing or selecting a forefoot cushion (1) according to claim 1, which is in particular stored on a computer readable medium or implemented as a signal, and particularly is accessible or controllable via a website, and which, when being loaded in the memory of a computer and being executed by a computer, causes the computer
a) to provide at least one form on the website, by means of which form data can be input and the computer reads and stores these data,
b) to execute a processing and evaluation of the input data and
c) to control a machine in response to the evaluated data, which machine produces the forefoot cushion (1) in accordance with the data or which provides the evaluated data for selection of the forefoot cushion (1) in response to the evaluated data.

9: Computer program product according to claim 8,
wherein
the computer provides selection means for selecting individualized combinations of features of forefoot cushions (1) on the website, in particular selection means for adaptation to the shoe size and for selection of the design of one or more zones (3, 5, 7), and the computer controls the machine in accordance with the data of the selection means and the machine produces the individualized forefoot cushion (1) according to the data or the computer provides the data for selecting a forefoot cushion (1).

10: A method for providing, for example for producing or selecting, a forefoot cushion, which forefoot cushion is in particular designed for insertion into shoes with heels, with a bottom side being applicable to a shoe and with a top side positioned opposite to the bottom side and which forms a lay-on surface for the foot (13), wherein the forefoot cushion (1) has at least one zone (3, 5, 7)—said zone being incorporated as a hollowing starting from the bottom side into the forefoot cushion (1)—for pressure relief of one or more metatarsal heads (21),
wherein
the forefoot cushion is provided, for example designed, in such a way that at least one zone (3, 5, 7) is not visible from the top side of the forefoot cushion (1), so that a flat, non-curved surface (9) is achieved in the upper part of the forefoot cushion (1) and
wherein the forefoot cushion (1) is flattened toward the side, so that the forefoot cushion (1) does not cover the whole foot sole but just a section of the foot sole.

11: A method for providing, for example for producing or selecting, a forefoot cushion according to claim 10,
wherein
the forefoot cushion (1) is designed in such a way that it comprises a first zone (3) for pressure relief of the first metatarsal head (21) and a second zone (5) for pressure relief of the fifth metatarsal head (21).

12: A method for providing, for example for producing or selecting, a forefoot cushion according to claim 10, wherein
the forefoot cushion (1) is designed in such a way that it has a third zone (7) for pressure relief of the second, third and/or fourth metatarsal head (21).

13: A method for providing, for example for producing or selecting, a forefoot cushion according to claim 10, wherein
the forefoot cushion (1) is designed in such a way that it comprises a raising (11), in particular a pelotte, on the top side, which raising (11) serves to support the arch area, in particular the transverse arch, of the foot (13).

14: A method for providing, for example for producing or selecting, a forefoot cushion according to claim 10, wherein
the forefoot cushion (1) is designed in such a way that it has an adhesive surface in at least one section of the bottom side.

15: A method for providing, for example for producing or selecting, a forefoot cushion according to claim 10, wherein
the forefoot cushion (1) is made at least partially from silicone, in particular from warm-crosslinking LSR-silicone rubber or cold-crosslinking silicone rubber, by injection molding.
